(19) United States
(12) Patent Application Publication
(10) Pub. No.: US 2010/0211592 A1
(43) Pub. Date: Aug. 19, 2010

(54) EMAIL RESPONSE TIME EXPECTATION SYSTEM

(76) Inventor: Mark Jonathon Brownlee, Waitakere (NZ)

Correspondence Address: JACOBSON HOLMAN PLLC, 400 SEVENTH STREET N.W., SUITE 600, WASHINGTON, DC, 20004, US

(21) Appl. No.: 12/452,737

(22) PCT Filed: Jul. 21, 2008
(86) PCT No.: PCT/NZ2008/000176

§ 371 Date: Apr. 16, 2010

(30) Foreign Application Priority Data
Jul. 20, 2007 (NZ) 556638

(51) Int. Cl. G06F 15/16; G06F 17/30; G06F 3/048

(52) U.S. Cl. 707/769; 709/206; 709/217; 715/764; 707/E17.014; 707/802

(57) ABSTRACT

An email client adapted to include an expected response time field in an email being sent is described. The email client also adapted to display the expected response time field of a received email that includes an expected response time field. An email including an expected response time is also described. An email server is described that can process the an email including an expected response time is also described.

### FIELD OF THE INVENTION

The present invention relates to an improved email communication system, software and method and more particularly, an improved email system, software and method for improving productivity and communication.

### BACKGROUND OF THE INVENTION

Email messages are used widely around the world, and are well known. One of the benefits of sending an email message is the (almost) instantaneous communication of the information in the email message. Such instantaneous communication capabilities may lead senders of email messages to believe that an instant reply may be inevitable.

One of the difficulties for a sender of an email when an email is sent, is knowing when the receiver of the email will respond. A query may obviously be inserted into the text of the message, asking the receiver to give an indication of the response time, but this process is time consuming and clumsy.

Emails are known to be able to have status levels of urgency (Normal, High, or Low) associated with them and this information is sent with the email to let the receiver have an idea of the status of the email. However, levels of urgency are relative to particular persons, and according to how many other processes take priority: Frequently, the sender's levels of urgency may be higher than the receiver's levels of urgency. There can be an expectation gap between what the email sender considers to be reasonable email response time and what the email recipient does, and this relative difference may cause frustration and inefficiency.

Where the receiver of the email is under pressure, and is not able to action or respond to the email by the set due date, then the sender's planning may be disrupted. In some instances, it may not be the deadline itself that is important, but rather the certainty of knowing when a response is due or an action is forthcoming, for the purposes of planning.

Microsoft® Outlook 2007 goes some way to overcoming this problem, in that allows a sender of an email to provide a flag which is sent with the email message for the receiver's benefit to show them when a response or action on the email is expected. This programme inserts an expected response time into the X-header field of an email sent from Outlook for display on the receiver's outlook system However, this solution has particular disadvantages in that it only works where both sender and receiver is using MS Outlook® 2007, and where MS Exchange® is used on receivers email servers. Where older systems are used, or where emails are being sent over web enabled email systems such as GMail or Hotmail, this service is not available.

As an example, if a person was seeking employment, they might email a person in a job recruitment agency, telling them about their work situation and asking them if their type of agency was the type of agency that could be of assistance.

The sender may, based on their expectations of receiving replies to emails, expect to get a response within 1-2 days but no later than 3 days. The sender may also want to hear back from the agency ASAP so that if the agency could not help, another agency could be approached.

However if a reply was not forthcoming within 3 days, uncertainty would arise as to what an appropriate time-frame to reply to the email would be. It might, for instance, be that in the agency's line of work, response times of 7 days is the norm.

In this way, it may not always be poor performance that can cause frustration, but rather a lack of communication about expectations.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun. The term “response time” is to be construed in this specification as meaning either a particular date and time by which a response is to be sent or action carried out, or a time period within which a response is to be sent or action carried out, and similar terms such as “response times” is to be construed accordingly.

The term “a response to the data transmission” is to be construed in this specification as meaning replying to the data transmission, or taking any action in response to the data transmission.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### OBJECT OF THE INVENTION

It is an object of the present invention to provide an improved email system and method which overcomes or at least ameliorates some of the abovementioned disadvantages or which at least provides the public with a useful choice.

It is a further object of the present invention to provide an improved email system and method having the ability to specify an expected response time that overcomes the above disadvantages or at least provides the public or industry with a useful choice.

### SUMMARY OF THE INVENTION

According to a first aspect, the invention may be said to broadly consist in an email client adapted to include an expected response time in an email being sent and to display the expected response time of a received email that includes an expected response time field.

Preferably said expected response time is stored in a field of said email.

Preferably said expected response time field is included as an X-header field of an email being sent.

Preferably said email client is adapted to allow a user who receives an email including an expected response time to communicate an adjusted expected response time to the original email sender's email client.

Preferably said email client includes the ability to sort emails based on said expected response time.

Preferably said email client includes a statistics module, said statistics module collecting data on expected response time and actual response time.

Preferably including a statistics display module for displaying statistics on expected response time and actual response time.

Preferably said statistics module forwards said collected statistics to a server for further processing.

Preferably said client includes an interface allowing a user to set parameters for adjusting the expected response time of incoming emails, said client processing each received email according to said rules.

Preferably said expected response time of outgoing emails are set according to a preference for the email address the email is sent to, said preference being stored in an address book, said email client having a default preference for cases when no specific preference is set.

According to a further aspect, the invention may be said to broadly consist in an email message including an expected response time.

Preferably said expected response time is stored in a field of said email.

Preferably said expected response time field is included as an X-header field.

According to a further aspect, the invention may be said to broadly consist in an email server adapted to process an email including an expected response time, said server responding to an email including an expected response time according to rules defined by a user and/or organisation.

Preferably said rules are set by a user using a user interface of an adapted email client.

Preferably wherein said expected response time is stored in a field of said email.

Preferably said expected response time field-is included as an X-header field.

According to a further aspect, the invention may be said to broadly consist in an email system including the email client of any one of claims 1 to 10.

According to a further aspect, the invention may be said to broadly consist in a method of sending an email including the step of including an email expected response time field in said email

According to a further aspect, the invention may be said to broadly consist in a response time expectation system, including
a processor;
digital storage media suitable for storing instructions and data;
a transceiver;
system instructions stored on the storage media configured for directing the processor to include expected response time information in a data transmission to a remote terminal, said expected response time information including data related to an expected response time for a response to the data transmission.

Preferably, the system instructions are configured to send
a data transmission to third party, which data transmission includes
   information relating to the expected response time for storage in database by the third party supplier, and
   an identifier code by which the third party database can be interrogated to return the expected response time.

Preferably, the expected response time information including data related to an expected response time which is sent to the remote terminal includes
a web link to the third party's site where the expected response time can be viewed, and
an identifier code by which the third party supplier database can be interrogated to return the expected response time.

Preferably, the data transmission is an email message.

Preferably, the expected response time information is stored in the body of the email message.

Alternatively, the expected response time information is stored in the X-header field of the email message

Preferably, the response time expectation system is an email client, a part thereof, or an addition thereto.

Preferably, the system includes
a screen display; and
the system instructions stored on the storage media are configured for
   receiving a data transmission from a remote terminal including information relating to an updated expected response time for a particular data transmission; and
   presenting an indication of the updated expected response time in association with the original data transmission on the screen display.

Preferably, the information relating to an updated expected response time received from the remote terminal is received from the receiver of the original email.

Alternatively, the information received from the remote terminal is received from a third party.

Preferably, the presentation of an indication of the updated expected response time is a web link to a web site, on which the updated expected response time is displayable.

Preferably, the information relating to an updated expected response time includes a web link to a third party website which will allow viewing of an updated expected response time.

Preferably, the presentation of the updated expected response time is in response to an interrogation of the system by a user, and the system includes instructions for carrying out said interrogation.

Alternatively, the updated expected response time is presented automatically on receipt of the updated information.

Preferably, the system instructions are further configured for sorting email based on the expected response times, or updated expected response times.

Preferably, the system instructions stored on the storage media are further configured for
receiving a data transmission from a remote terminal, said data transmission including expected response time information indicative of the time expected by the sender of the data transmission for an action to be performed by the receiver of the data transmission; and
updating the expected response time to reflect the update.

Preferably, the system instructions are further configured for communicating the updated expected response time to the sender of the data transmission.

Alternately, the system instructions are further configured for communicating the updated expected response time to a centralised database where the updated expected response time can be viewed.

Preferably, the system instructions are further configured for presenting a user operable interface for general adjustment of expected response times of received emails.

Preferably, the system instructions are further configured for presenting a user operable interface for adjustment of expected response times of received emails based on the characteristics of that email.

Preferably the adjustment of expected response times of received emails based on the characteristics of that email are based on characteristics such as
sender;
sender group;
user defined groups;
when the email is received;
location of sender; or
any other known characteristic.

Preferably, the system instructions are further configured for presenting a user operable interface for adjustment of expected response times of received emails based on predetermined rules.

Preferably, the predetermined rules relate to
work carried out,
whether a user is on leave or not,
the number of emails already having been received at that terminal that day, or over any other time period
the number of unread emails in the inbox at the terminal.
the amount if time spent responding to emails already over a preset time period;
the number of emails already responded to in a predetermined time period;
a preset default;
any other rule.

Preferably, a preset default rule is settable by means of a graphical user interface shown as a slider bar, which slider bar is adjustable by a user according to their preference.

Preferably, the system instructions stored on the storage media are further configured for recording details of when the data transmission is responded to or actioned.

Preferably, the system instructions are further configured for communicating recorded details of when data transmissions are responded in relation to their expected response time, or in relation to their updated expected response times.

Preferably, the system instructions are further configured for raising an alert if a predetermined amount of emails are not responded to by the expected response time or updated expected response time, or if a particular predetermined rate of emails per hour or day are not being responded to by the expected response time or updated expected response time.

According to a further aspect, the invention may be said to broadly consist in a data logging system comprising
digital storage media;
a transceiver; and
logging software configured for
   receiving statistical data from a remote terminal, said data being indicative of indicative of when data transmissions are responded to in relation to their expected response time, or in relation to their updated expected response times;
   storing the statistical data;
   interrogating the stored statistical data to present information relating to data received from a remote terminal, or defined groups of remote terminals.

Preferably, the logging software is configured to display the results the said interrogation on a display means.

Preferably, the logging software is configured to display the results of the said interrogation online over the Internet.

Preferably, the response time expectation system includes the data logging system.

Preferably, the transceiver is a network card and/or network connection.

According to an further aspect, the invention may be said to broadly consist in a method of communication an expected response time, said method comprising the steps of
directing a processor to include expected response time information in a data transmission to a remote terminal, said expected response time information including at least data indicative of the response time expected by the sender of the data transmission for a response to the data transmission; and
sending the data transmission to a remote terminal over a communications network.

Preferably, the method of communication an expected response time includes the steps of
sending a data transmission to a third party over a communications network for storage on a database, which data transmission includes
   information relating to the expected response time for storage in database by the third party supplier, and
   an identifier code by which the third party database can be interrogated to return the expected response time.

Preferably, the expected response time information including data related to an expected response time which is sent to the remote terminal includes
a web link to the third party's site where the expected response time can be viewed, and
an identifier code by which the third party supplier database can be interrogated to return the expected response time.

Preferably, the data transmission is an email.

Preferably, the expected response time information which is included in the email is included in the body of the email.

Alternatively, the expected response time information which is included in the email is included in the X-header field of the email.

According to a further aspect, the invention may be said to broadly consist in a method of updating an expected response time for a data transmission, said method of updating comprising the steps of
receiving a data transmission from a remote terminal, said data transmission including response time information indicative of the time expected by the sender of the data transmission for an action to be performed by the receiver of the data transmission; and
updating the response time information to reflect a changed response time.

Preferably, the method of updating an expected response time includes the step of sending information indicative of an updated expected response time to a remote terminal.

Preferably, the remote terminal is the remote terminal that sent the original data transmission.

Preferably, the method of updating an expected response time includes the steps of
sending a data transmission to a third party over a communications network for storage on a database; which data transmission includes
   information relating to the updated expected response time for storage in database by the third party supplier, and
   an identifier code by which the third party database can be interrogated to return the updated expected response time.

Alternatively, the method of updating an expected response time includes the steps of
accessing a third party service provider's website
interrogating a database of stored expected response times associated with data transmission with a supplied identifier code; and
updating the expected response time associated with a particular data transmission.

Preferably, the updated expected response time information including data related to an updated expected response time which is sent to the remote terminal includes
a web link to the third party's website where the updated expected response time can be viewed, and
an identifier code by which the third party supplier database can be interrogated to return the updated expected response time.

Preferably, the method of updating an expected response time includes the step of presenting an indication of the updated response time in association with the original data transmission.

Preferably, the method of updating an expected response time includes the step of recording details of when the data transmission is responded to.

Preferably, the method of updating an expected response time includes the step of communicating recorded details of when data transmissions are responded in relation to their expected response time, or in relation to their updated expected response times to a remote terminal.

According to a further aspect, the invention may be said to broadly consist in a method of receiving an updated expected response time comprising the steps of
receiving information related to an updated expected response time from a remote terminal; and
updating the expected response time associated with a data transmission.

According to a further aspect, the invention may be said to broadly consist in a method of receiving an updated expected response time comprising the steps of
receiving a data transmission from a third party indicative of an updated expected response time associated with a previous data transmission,
accessing a third party's website to view the updated expected response time.

Preferably, the method includes the steps of
downloading the updated expected response time and
updating the expected response time associated with a data transmission.

Preferably, the data transmission from a third party indicative of an updated expected response time includes a web link, and an identifier code with which a database can be interrogated to return an updated expected response time.

Preferably, the step of accessing the third party's website to view the updated expected response time includes the step of sending the identifier code to the third party's website for interrogation of a database to return an updated expected response time.

Preferably, on interrogation of the third party's data base, the updated expected response time associated with the sent data transmission is automatically updated.

According to a further aspect, the invention may be said to broadly consist in a method of providing a response time expectation system time for a data transmission comprising the steps of
receiving a data transmission associated with a spearte data transmission including:
   data indicative of an expected response time for the separate data transmission and
   an associated identifier code
storing the data indicative of an expected response time and associated identifier code for interrogation;

Preferably, the method of providing a response time expectation system time for a data transmission includes the steps of
receiving an identifier code from a receiver of the separate data transmission
interrogating the stored identifier codes for a similar identifier code to the one received; and
retrieving the associated data indicative of an expected response time.

Preferably, the method of providing a response time expectation system time for a data transmission includes the steps of
sending the associated data indicative of an expected response time to a remote terminal associated with the receiver of the separate data transmission.

Preferably, the method of providing a response time expectation system time for a data transmission includes the steps of
displaying the associated data indicative of an expected response time.

Preferably, the method of providing a response time expectation system time for a data transmission includes the steps of
receiving data indicative of an updated expected response time; and
storing the data indicative of an updated expected response time.

Preferably, the method of providing a response time expectation system time for a data transmission includes the steps of
sending a data transmission to the sender of the separate data transmission indicative of the updated expected response time.

Preferably, the method of providing a response time expectation system time for a data transmission includes the steps of
receiving an identifier code from a remote terminal associated with the updated expected response time;
interrogating the stored data indicative of the updated expected response times with the identifier code to retrieve data indicative of the updated expected response time;

Preferably, the method of providing a response time expectation system time for a data transmission includes the steps of
sending the associated data indicative of an updated expected response time to a remote terminal

Preferably, the remote terminal is associated with the sender of the separate data transmission.

Preferably, the method of providing a response time expectation system time for a data transmission includes the steps of
displaying the associated data indicative of an updated expected response time.

According to a further aspect, the invention may be said to broadly consist in a method of logging and displaying response time data comprising the steps of
receiving statistical data from a remote terminal, said statistical data being indicative of when data transmissions are responded to by the remote terminal in relation to the expected response time of the data transmission, or in relation to the updated expected response times of the data transmission; and
storing the statistical data.

Preferably, the method of logging and displaying data includes the step of
interrogating the stored statistical data to present statistical information relating to data received from a remote terminal, or defined groups of remote terminals.

According to a further aspect, the invention may be said to broadly consist in an installation system for providing a system for modifying emails as described above, said system for providing a system comprising
digital storage media;
installation instructions stored on said digital storage media, said installation instructions being configured for directing a processor to install system instructions on a second digital storage media, said system instructions being configured for directing a processor to include response time information in a data transmission to a remote terminal, said response time information including at least data indicative of the time expected by the sender of the data transmission for an action to be preformed by the receiver of the data transmission.

Preferably, the data transmission is an email message.

Preferably, the response time information is stored in the body of the email message.

Preferably, the installation instructions are for further directing a processor to install system instructions on a second digital storage media configured for
receiving a data transmission from a remote terminal including updated information relating to the expected response time; and
presenting an indication of the updated response time in association with the original data transmission.

Preferably, the system for providing includes download instructions for making said installation instructions available to a remote terminal.

Preferably, the processor is at a remote terminal.

According to a further aspect, the invention may be said to broadly consist in an installation method of installing a system for modifying emails as described above, said installation method comprising the steps of
making computer readable installation instructions available to users, said installation instructions being configured for directing a processor to install system instructions on a second digital storage media, said system instructions being configured for directing a processor to include response time information in a data transmission to a remote terminal, said response time information including at least data indicative of the time expected by the sender of the data transmission for an action to be preformed by the receiver of the data transmission.

Preferably, the installation instructions are made available online over the Internet.

Alternatively, the installation instructions are made available on a digital storage media.

Preferably, the digital storage media is a CD, DVD, flash memory, hard disc, or the like.

Preferably, the data transmission is an email message.

Preferably, the response time information is stored in the body of the email message.

Preferably, the installation instructions are for further directing a processor to install system instructions on a second digital storage media configured for
receiving a data transmission from a remote terminal including updated information relating to the expected response time; and
presenting an indication of the updated response time in association with the original data transmission.

Preferably, the system for providing includes download instructions for making said installation instructions available to a remote terminal.

Preferably, the processor may be at a remote terminal.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

Disclosed embodiments and methods of utilizing the invention will be further described, with reference to the accompanying figures, by way of example only and without intending to be limiting, wherein;

FIG. 1 is an email client incorporating the features of the present invention, allowing a user to set the expected response time, and

FIG. 2 is a flow diagram of an email sending process;

FIG. 3 is a flow diagram of a receiving process and an expectation response time update process;

FIG. 4 is a flow diagram of a receiving process and an expectation response time update process;

FIG. 5 is a flow diagram of an email sending process;

FIG. 6 is a flow diagram of a method of logging and displaying response time data; and

FIG. 7 is a response time expectation system.

### DETAILED DESCRIPTION OF THE INVENTION

With reference to the above drawings, in which similar features are generally indicated by similar numerals, a response time expectation system in the form of an email client for setting an expected response time by which an data transmission in the form of an email is to be responded to or actioned, according to a first aspect of the invention is generally indicated by the numeral 100.

In one embodiment now describe there is provided a solution that allows an email sender to set a global email response time, to have the expected response time adjusted by the receiver of the email, and to have the adjusted expected response time sent back to the original sender of the email.

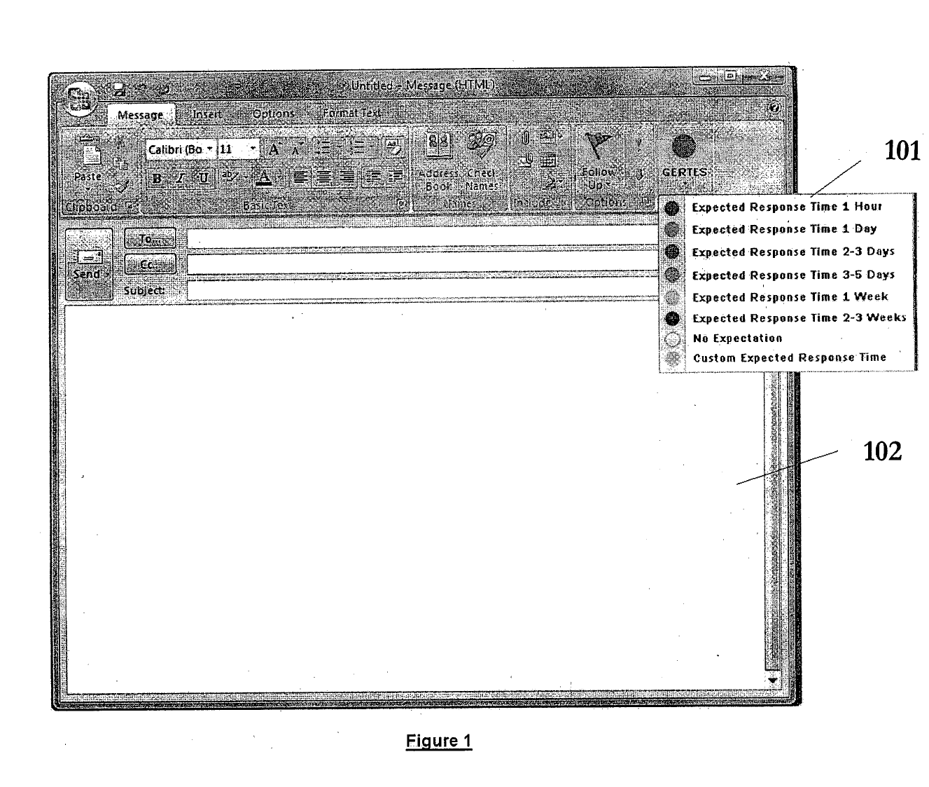

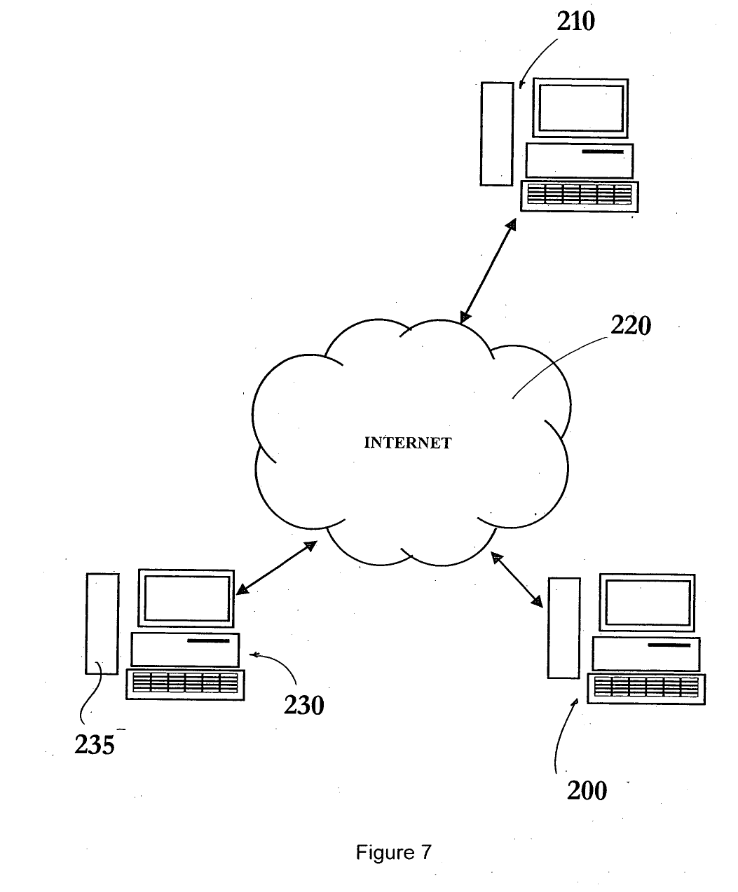

The present invention would be implemented as an email client, part thereof, or as an addition thereto. It is envisaged that the system would include instructions in the form of software (not shown) that is installed on a PC- or MAC-type computer of a sender (shown in FIG. 7 as numeral 200) of an email or a receiver (shown in FIG. 7 as numeral 210) of an email as either standalone software (shown as 101 on FIG. 1), or as a software add-on which interfaces with email software that is already available. It is envisaged that in a preferred embodiment, the software would interface with existing email software resident on a user's computer, such as MS Outlook® or the like. It is further envisaged that the software will be compatible with a transceiver mechanism such as a network card or the like to cause data to be received and transmitted via network such as the Internet 220.

However, it is also envisaged that the software may interface with distributed software such as web enabled email. The software will be installed on a user's PC on digital storage media in the form of the PC hard drive, and will direct operation of the processor of the PC, to display results of its directions on the screen of the PC in a known manner.

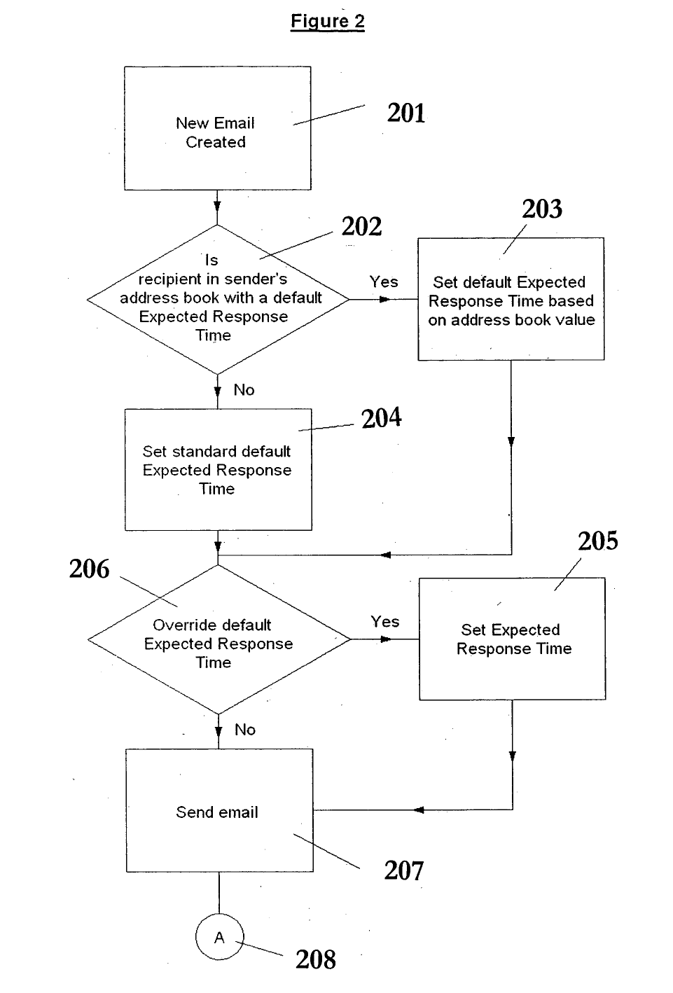

As shown in FIG. 2, the software will cause emails to be modified with the addition of information before being sent. The email may be modified the software automatically inserting an expected response time (ERT) by comparing the address of intended recipient against predetermined rules for addressees in the address book (as shown by numerals 202 and 203), or by setting an expected response time manually (as shown by numeral 206).

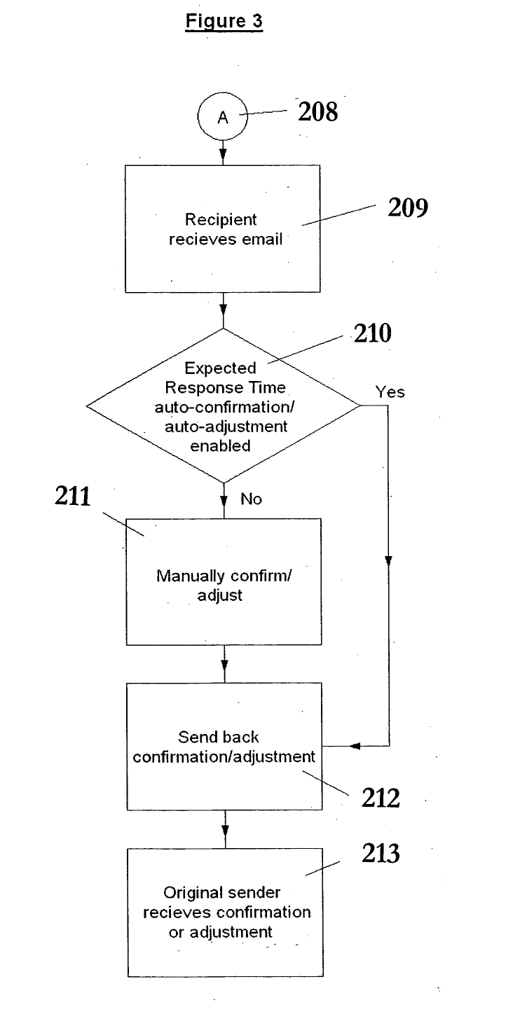

The information added to the email will include data indicative of an expected response time expected by the sender of the email for a response to the data transmission. It is envisaged that the actual response time may not be sent per se, but that data which is able to be translated into a response time will instead be sent. The email is then sent (as shown by numeral 207). Box A (as shown by numeral 208) shown in FIGS. 2 and 3 indicates where one process stops and the following process starts.

In one embodiment, the email client software such as Microsoft Outlook or Mozilla would include a selector to allow the sender to choose an expected response time. The selector of an email client when sending a message is illustrated in FIG. 1.

In a preferred embodiment the expected response time would be indicated by the client software to the user as a specifically formatted dot (shown as 102 in FIG. 1) indicating to the email's recipient the sender's expected email response time. The email client would include in the sent email a field that indicates the senders expected response time. This field could be an X-header including the expected response time.

It is envisaged that the dots could have the following characteristics:

Red Dot (Expected Response Time 1-2 hours)

Orange Dot (Expected Response Time 1 Day)

Blue Dot (e.g. Default) (Expected Response Time 2-3 Days)

Crimson Dot (Expected Response Time 3-5 Days)

Silver Dot (Expected Response Time 1 Week)

Maroon Dot (Expected Response Time 2-3 Weeks)

Clear Dot (No Expectation)

Gold Dot (Custom Expected Response Time)

When a recipient receives an email with an included expected response time field or header, the email client would display a dot representative of the expected response time set by the sender in terms of when the sender should receive a reply.

It is expected that email client software would provide a control tip allowing users new to the system to get a Control Tip Text saying, for example, “Expected Response Time: 2-3 Days”.

It is envisaged in the preferred embodiment that the sender's email client software will allow the setting of a default expectation in a similar manner to setting the default priority. The email client would also allow a user to select from the entire different coloured dot selections available with their respected descriptions.

The email will then be received at the terminal to which it is addressed (as shown by numeral 209). At this point, the additional information sent with the email which is indicative of the expected response time person sent by another

The expected response time system and method could in a further embodiment provide a system and method allowing a recipient of the email to respond to the originals senders expected response time, as shown in FIG. 3.

For example the recipient thinks that it is an unreasonable response time expectation, or will not be able to meet the expected response time, they can adjust the dot on the email received by selecting another dot from the emails drop-down list. The email client when adapted to include the features of the present invention would then automatically communicate with the original mailer's email client and send an expectation-change message. The expectation change message may be sent in an email that a client that includes the present invention would recognise as an expectation change message. In an alternate embodiment the expectation change message could be sent via some other network protocol.

A particularly preferred option is communication via an email with XML code in the body or in the expectation time header or field. The email program would automatically store this email in a specific sub-folder under the Inbox folder such as “Expectation Changes”. Messages could automatically be marked “read” if so desired. In an alternative embodiment the messages could be hidden by default or immediately deleted.

In a further embodiment the expectation change messages could be silent and hidden, e.g., with no mail-icon appearing in the system tray or on the email-client bottom-right icon panel. In this embodiment, the updated expected response time may be sent as data transmission (and not an email) which is only communicated to the sender of the original email as an updated expected response time in relation to the original sent item. The email client at the original sender of the email would then update the expected response time on the sender's terminal to reflect the update in association with the original sent email.

In yet a further embodiment a specific icon could appear next to the location where the normal mail-received icon appears indicating updates. In a further embodiment if emails have been received along with expectation changes, then a small icon could be overlaid on the top-right of the mail icon.

In a further embodiment the original sender's email program would display the updated dot on the particular sent e-mail's toolbar icon, partially eclipsing the original dot with the new dot in the foreground and old dot in the background. This allows the sender to see what their original expectation was and what the updated (received) expectation is.

The following dots could be used to indicate the recipient's response. For example
a block dot would mean that the user would not be responding to the email at all—they are not interested.
a coloured or type of dot could mean that the user would not be responding to the email at all—“not interested and please don't contact me again”, i.e., unsubscribe.

It is anticipated that email client software would allow email users to sort their emails in their Inbox, Sent Items and other folders by the expectation dot. For example a user's Inbox could be sorted to allow a user to show:

Replies Needed To Be Sent Today

Replies Needed To Be Sent This Week

Replies Needed To Be Sent Sorted by Expectancy Date

Overdue Replies Needed To Be Sent

A users Sent Items mail box could be sorted to show:

Replies Expected To Be Received Today

Replies Expected To Be Received This Week

Replies Expected To Be Received Sorted by Expectancy Date

Overdue Replies Expected To Be Received

In a further alternative the real response expectation dates (e.g. May 15, 2009) could also be calculated and shown where appropriate, for example in the Control Tip Text for a dot.

In a further embodiment the expectation system could allow a user to indicate a preferred or desired response time within the expected response-time selection.

This, for example, could be achieved by a smaller dot within a dot, similar to a “target” dot. For example, there may be a blue dot with a little red dot inside. This would indicate that the sender expects the email to be responded to within 2-3 Days but would really like it if it could be responded to within the hour—if at all possible.

It is envisaged that the desired or preferred response time could be amended by the recipient in a manner described above. Further in terms of displaying the changed desired or preferred response time the internal dot may also be another shape if desired, e.g. square.

In a further embodiment, the expected response times can be embedded by the sender's software in the body of an email as text, and similar email client software installed at the receiver's end is used to extract the relevant information from the body of the email. This is advantageous in that it could allow similar functioning to that described above where MS Exchange® is not used by the receivers email server (and the X-header fields are not available). It is envisaged that this feature is particularly advantageous as many email recipients worldwide would not otherwise be able to use the functionality of the software.

Automatic Rules

In one embodiment, the software is configured for presenting a user operable interface for automatic adjustment of expected response times of received emails (as shown by numeral 210) based on the characteristics of that email. In the embodiment shown in FIG. 3, the ERT can be automatically updated and sent, or automatically updated and sent after giving a user the option to update manually (as shown by numeral 211). The adjustment of expected response times of received emails based on the characteristics of that email can be based on characteristics such as
sender;
sender group;
user defined groups;
when the email is received;
location of sender; or
any other known characteristic.

Further, it is envisaged that the software is further configured for presenting a user operable interface for adjustment of expected response times of received emails based on predetermined organisational or personal rules.

Preferably, the predetermined rules relate to
work carried out,
whether a user is on leave or not,
the number of emails already having been received at that terminal that day, or over any other time period
the number of unread emails in the inbox at the user's terminal;
the amount if time spent responding to emails already over a preset time period;
the number of emails already responded to in a predetermined time period;
a preset default; or
any other rule.

It is envisaged that rules could be implemented within the email client to automatically adjust incoming email ERT expectations. For example from 1-day expectations to 3-4 day expectations or to 7-day expectations when a user is very busy.

Similarly, a predefined set of rules can be triggered by the user indicating to the system how busy they are. The busy indicator is preferably a graphical slider (e.g. from 1 to 10) that a user can use to indicate how busy they are. Alternatively a user could set a busy level by setting a number. Users that are under pressure and do not expect to meet the expected response times can move the busy indicator towards 10. The system of the present invention using a pre-defined set of rules will globally (within the email client) adjust all expectations, making adjustments to extend response-expectation times.

For example a user may only be expected to answer 20 incoming emails per day. This may be in order to balance their time (or for eye health reasons) to do other types of work that needs attending to. The ability to set the number of emails that are to be answered in a given day is a further advanced feature of the present invention.

When this option is set the system will automatically adjust email response-time expectations to take into account this decision. For example, if there are 100 emails in a user's Inbox, the second 20 will be delayed by 1 day, the next 20 by 2 days and so on.

Further a user may only be expected to spend 3 hours per day typing responses to incoming emails, thereby allowing their time to be balanced, and to do other types of work that needs attending to.

In this case rules can be set to cause the system the system to automatically adjust email response-time expectations to take this into account. In such a case, time spent typing email responses is automatically logged. Then, after determining the average typing time per email, the number of emails not responded to in the Inbox, delay calculations can be automatically made by the system.

It is envisaged that the present invention would allow a user to set the number of hours available to respond to emails and implement a feature to log the time spent responding to emails and based on the logged time and the available time adjust the response times.

The present invention will allow a user to set a default response time so that every incoming email is automatically sent a change response notification to the users default response time.

The present invention as envisaged would also allow a user to set a “holiday” or “work on pause” mode. This would be implemented by allowing a user to enter a date range indicating when they will be on holiday. Based on that date range the system will push the expected response into the future accordingly. Optionally an “O” (Out of office) letter or “V” (Vacation) letter, or an iconic representation of these could appear inside a dot associated with an email.

Some people struggle with the temptation of email/text messaging e-diction (addiction). The present invention may help them to relax and know that all emails will be always taken care of, e.g. they don't have to check email every 10 minutes (often at unusual hours of the day). If these “e-diction susceptible” people know that they won't “disappoint” people who send them a fresh email then they may not feel the urge to “stand-guard” or run to the email-client.

“E-diction” susceptible people could be more relaxed in the knowledge that all emails are handled in a systematic way and not only they but also the other party will know this. And if such users hear a new-mail chime they may also not feel as obsessed to look at it:

In this way, the system will allow people to work more efficiently since productivity won't be lost as much from task interruption and changing. Also they will have lower work-stress levels.

In a further embodiment, an email user can let an email sender know that they agree to the incoming expected response time. A thin line around the circumference of the dot shown in a different colour, e.g. black, white, or a lighter or darker tone of the original dot could, for example, be displayed to represent the acknowledgment. This confirmation could be made automatically for all incoming emails or made automatically after the email is read, after another action or according to specific user-defined rules. A white-list or black-list of senders could exist to automate this too.

When an expectation is met, a little golden tick, (or other visual cue) could appear inside a dot (or golden circle around circumference). If an expectation is not met, a cross or optionally subtle cross can appear in the dot.

In a further embodiment the default expectation both for sent and received emails could be set based on a standard default or the recipient's address book entry. If based on the address book entry, the default dot may be based on:
An average of the last 10 dots sent or amended. For example, if Sally Slow most often needs 3-5 days to respond to emails, her default dot would be set to 3-5 Days in Joe's address book
The users (e.g. Joe's) discrete default dot setting for this person (e.g. Sally).

Additionally default expectations may be based on user-defined rules, for example, first-time contact may default to the 1-day expectation.

In a further embodiment, when a dot is due today, it may slowly pulsate or spin. Similarly it could also pulsate or spin albeit slower if it is due this week or due in another specified time period. Optionally other shapes may be used other than just round dots. For example, triangles, squares, rectangles, octagons etc. may be used. Further, different shapes may correspond to different expectation values. Optionally, customizable, user-defined icons may be used to represent different expectation values and attributes.

Optionally, a user can toggle functionality to indicate, on the dot, the appropriate colour or other indicator representing time to go before the dot is due to be responded to. For example,
1 Week dot due today
all dot colours could be toggled to display the time-to-go colour.

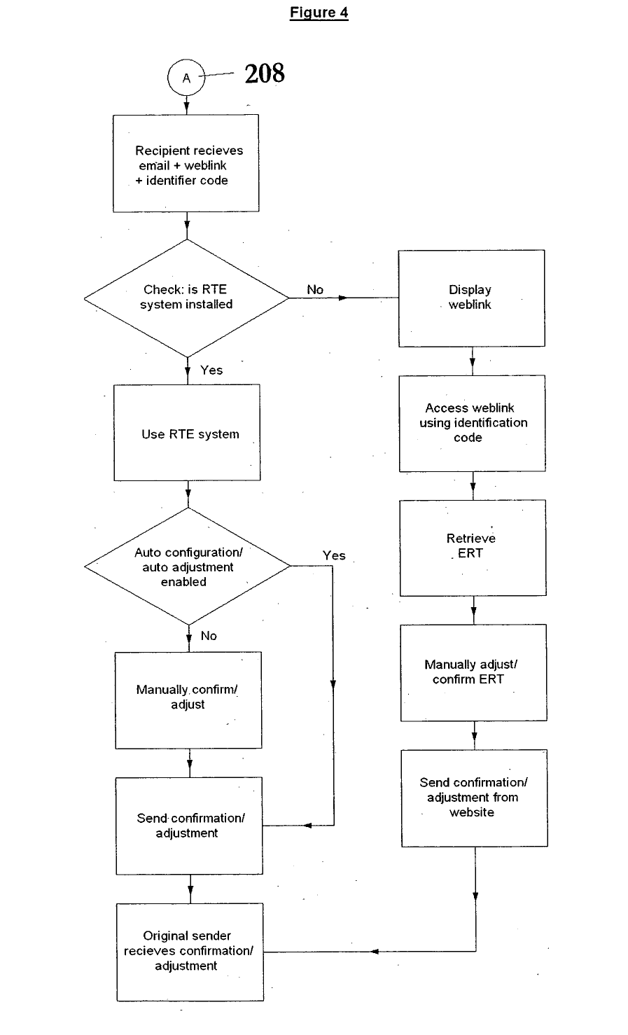

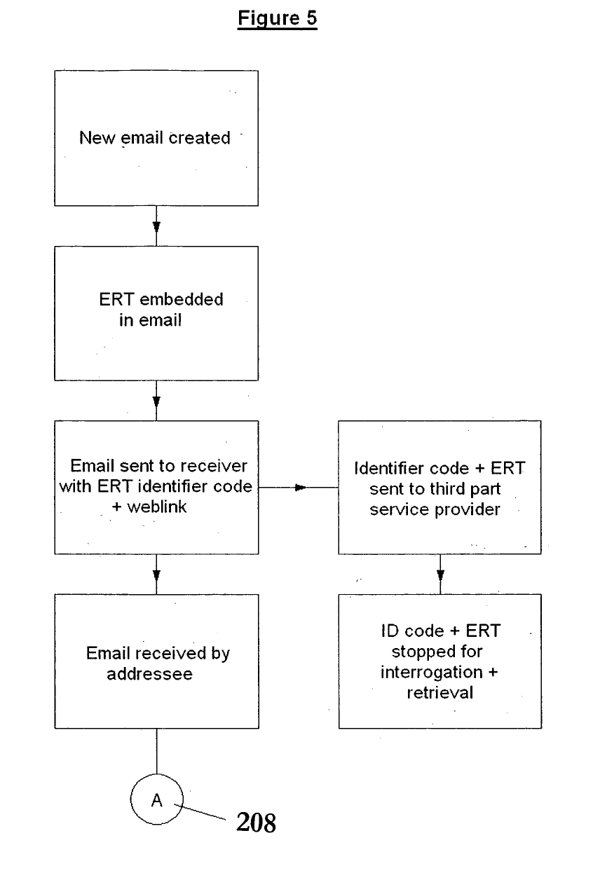

A further advantage of the current invention is provided by the incorporation of a third patty functionality in the method and system as shown in FIGS. 4 and 5. It must be noted that any services provided by a third party described below, could also be provided internally by a business (for example by a different division), and the services so provided can be publicly available, or only internally available to selected users. The main idea behind using a third party 230 is the central availability of information, which information can be interrogated by others where required.

In one embodiment, such information may be publicly available, while in another embodiment, the information may be for internal use only (for example over a local Intranet)

Another advantage of using a third party is the use of distributed software in “distributed computing” where excessive resources ate not required by the individual terminals, instead placing reliance on external third parties to provide resources.

It is envisaged in one embodiment that when an email is sent by a sender, a data transmission can simultaneously be sent to a third party as shown in FIG. 5. It should be noted that the email could be sent by Internet based email software such as GMail, Hotmail or the like, and can be initially made up by using software available online from the third party. This includes setting an ERT online for inclusion in the email to be sent. The email includes information relating to the expected response time, and at least one identifier code. The identifier code is retained as an identifier of the email that was sent in the sender's “Sent Items” folder or other list of emails with expected response times (ERT's).

The ERT would be stored by the third party, together with the associated identifier code. The same identifier code is sent embedded in the email to the receiver, together with information allowing the receiver to reference the third party, such as a web link. In such a case, data indicative of the ERT need not be sent with the email to the receiver. In one embodiment, the sender's software will embed the following in the email sent to the receiver of the email:
a web link to the third party's site where the expected response time can be viewed, and
an identifier code by which the third party supplier database 235 can be interrogated to return the expected response time.

It is envisaged that such a system can be used where the receiver of the email does not have the email client software installed on their computer, or where a Net based email programme is being used by them. This procedure is shown in FIG. 4 in addition to the procedure when the software is installed as an email client. When the web link is clicked on by the receiver, it causes the receiver to access the website and interrogate the stored identifier codes to retrieve the ERT associated with the identifier code sent to the receiver. This will coincide with the identifier code sent by the sender to the third party and stored by the third party. In another embodiment, the web link and the identifier code need not be one, but the identifier code can be typed in manually by the receiver of the email. Once the ERT is accessed, this information may be automatically downloaded for use by the receiver, or it can be updated on the third party database 235.

In one embodiment, the receiver of the email can opt to update the ERT if they believe that they will not be able to meet it. On updating this ERT, the third party software then sends an update email or data transmission to update the expected response time information at the terminal where the email was originally sent from. The data transmission to the sender may be to inform them of the update, or to communicate the actual updated ERT with them. In another embodiment, the third party merely retains the updated ERT, for access by the sender at a later time. In another embodiment, the data transmission automatically causes the ERT to be updated on the sender's system 200.

In yet another embodiment, where the sender of the original email does not have the ERT software installed on their computer and have set an ERT online in the first instance the receiver's software could send a similar email back to the sender with a weblink and an associated identifier. The sender of the initial would then need to access the updated ERT on the third party website by similar means.

As an example, where email clients that don't have the expectation system software installed, an introductory text phrase may be appended to the bottom of each email, for example:

“This email utilizes the email response-time system. The expected response-time for this email is

Blue Dot (2-3 Days)

For more information on the GERTES system and how you can utilize it visit http://www.xyz.com”

In this way, the software may be marketed virally. At the web address above, a visitor would be introduced to the response expectation system, and could also be allowed to download it from this site.

Further, where an email is received from a sender who does not have the software installed as an email client, the following type of message can be sent as a once off message:

“Thank you for your email Fred. Just to let you know, I am using the GERTES email response-time expectation system and my default response time is set to 2-3 Days. Also, my average response time for the last 30 days is:

### [Graphical Performance Badge]”

As shown above, it is envisaged that information indicating historical real or targeted future email response performance can be included in an email sent using the response time expectation system.

In yet another embodiment, the email itself may be updated by several links to the third party's service provider's website which, when clicked on, automatically functions to update the expected response time information, which updated response time information is sent to the original sender of the email. As an example, the following text could be inserted;

“The expected response time is X hours

To change the expected response time to Y days, click here: [Y days weblink]

To change the expected response time to Z days, click here: [Z days weblink]”

On clicking on one of the web links, it is envisaged that the necessary identifier information will be sent from the receiver's terminal to the third party to interrogate the database to find and update the relevant expected response time information, and cause an updated expected response time data transmission to be sent to the sender of the email.

It is envisaged that where the system is installed in, interfacing with or as part of an email client, this would allow users (both senders and receivers) to display additional columns in the email client such as time to go, response time deadline date etc. A user would then be able to sort their email based on such columns.

In a further embodiment the time remaining to complete the response may be displayed within the dots like an 8-ball. Varying thicknesses of numbers could represent Weeks, Days and Hours. E.g. a Fat “1” could represent 1 Week to go. A skinny 3 could represent 3 hours to go.

Performance Analysis

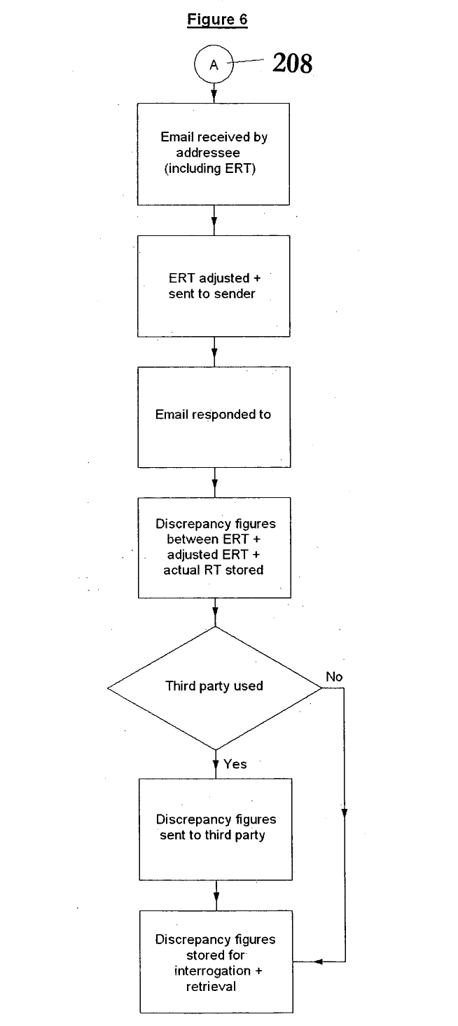

In a further embodiment it is expected that the email client software including the present invention would allow statistical information relating to ERT ‘s updated ERT's and actual response times to be saved and sorted on a database for analysis as shown in FIG. 6.

It is envisaged that when ERT's are responded to, details relating to the transaction are saved, either by sending the details to a central database at the time, or by the user's system for later extraction to a central database. The data base is then searchable for statistical information related to the transactions saved.

For example, all email addresses in the user's address book could be listed showing how well each client met the user's response time expectations.

Such statistics may include:
How many deadlines were missed
How many dots slid (moved in time (see Auto Feedback System above) because the user ran out of time to respond) and an average slide % figure
How many emails were automatically passed on to another designated team member because the required responses weren't going to be made in time. This manually confirmed pass-on and automatic pass-on would also be an advanced feature of the system.

Group, departmental and enterprise-wide email sending and email recipient performance can also be analyzed. This could allow an organization to get a feel for how well their staff is treating their customers—and how well customers and other third parties are treating the organization's staff in terms of timeliness relating to email correspondence. In the preferred embodiment this feature could be implemented at an email server level.

In yet a further embodiment the email client may submit whether expectations were met or not met, passed-on and other information to a centralized database for storage, or store the information itself for later downloading. This centralised database may be within a firm, or may be provided by a third party service provider.

Where this information is sent within a firm, it can be stored and used for performance analysis. Where this information is provided to a third party (whether a separate internal service provider, or a third party service provider), it is envisaged that this information could be grouped together by firms, departments or the like, and can be made publicly available as performance indicator for a public service oriented business. This is so that anyone else could discern that person's or their organization's reputation.

A web visitor could type-in the particular person's email address or domain name, and perhaps the performance field to be searched and the website would then display stored performance indicators. These may be for example an expectation reputation ranking them from 1 to 10. As an example, the following could be displayed for the individual and/or organization:

Number of expectations met (Total, Year, Month)

Number of expectations passed-on (Total, Year, Month)

% Expectations Met (Total, Year, Month)

% Expectations Not Met (Total, Year, Month)

Average Expected Response Times

Average Updated expected response times,

Average Actual response times.

Average difference between Expected response times, updated expected response times and actual response times.

Total Emails Received (Today, Total, Year, Month, Week)

Total Emails Sent (Today, Total, Year, Month, Week)

Any other similar relevant information

The emphasis would be on whether or not people met the expectation times they communicated. And whether or not their actual response times had met either the expected response times, and/or updated expected response times.

It is envisaged that the third party service provider website, or a firm's intranet website could also act as a portal for users of the present invention to view their statistics.

In a further embodiment the system could allow users to indicate their Reputation/Performance using a dynamic iconic verification badge could be placed on people's web-sites similar to Verisign, BBB etc.

The flow of email and other communication between email clients incorporating the present invention is illustrated in FIG. 2.

The present invention could also be applied to mobile phone Text messaging, Snail Mail and other forms of global communication.

Some of the functionality of the email client could in an alternative embodiment be incorporated into an email server. When incorporated into a server when a new mail is received by the mail server, the mail server looks up the recipient's account information stored within the mail server's database to see what the appropriate automatic expected response time should be. The expected response time could be set as a personal preference or as a corporate preference.

If no preference is set then the server would pass the email on without sending an automatic response. For example, assuming a new email is received with an expected response time of 1 hour, the server will look to see if the user has set, via an interface into the mail server or otherwise, or if a mail server group/organization policy has been set. If the default was set at 2-3 days then the server would adjust an incoming 1 hour expectation to a 2-3 Day expectation. The mail server would then automatically email or otherwise communicate with the email sender the updated value.

It is envisaged that included in a user's account information could be address book expected response settings for the user's various contacts and a default “new contact” response times for example 1 Week.

Further the server could optionally keep a record of all emails received for the last ‘n’ number of days that haven't been responded to and adjust (slide) the expected response time if necessary. For example, if a user sets his or her status to ‘on vacation’ or away for a certain time period range or ‘pause email response’, the mail server would periodically (e.g. daily or hourly) check for the user's status and send updates to people who had previously emailed.

Optionally some users may want the mail server to enforce a quota system as previously described, as for example, “I only want to answer 20 emails per day”. If this information is set (e.g. via an interface into the mail server and stored for that user account) then the mail server could hold back delivery of emails exceeding the quota until the next day or time period specified. In such instances the mail server could automatically send updates to the email senders.

It is envisaged that the software for installation as part of or interfacing with an email client will be made available online for download by known means, or will be provided as a digital storage media such as a CD or DVD with instructions for installing the software on a user's computer. It is envisaged that the installation instructions will cause the installation of software for setting ERT's and sending them, as well as for updating and sending ERT's, although this may not necessarily be the case.

Where in the foregoing description reference has been made to elements or integers having known equivalents, then such equivalents are included as if they were individually set forth.

Although the invention has been described by. way of example and with reference to particular embodiments, it is to be understood that modifications and/or improvements may be made without departing from the scope or spirit of the invention.

In addition, where features or aspects of the invention are described in terms of Markush groups, those skilled in the art will recognise that the invention is also thereby described in terms of any individual member or subgroup of members of the Markush group.

1. An email client adapted to include an expected response time in an email being sent and to display the expected response time of a received email that includes an expected response time field.

2. The email client as claimed in claim 1 wherein said expected response time is stored in a field of said email.

3. The email client as claimed in claim 2 wherein said expected response time field is included as an X-header field in an email being sent.

4. The email client as claimed in claim 1 wherein said email client is adapted to allow a user who receives an email including an expected response time to communicate an adjusted expected response time to the original email senders email client.

5. The email client as claimed in claim 1 wherein said email client comprises the ability to sort emails based on said expected response time.

6. The email client as claimed in claim 1 wherein said email client comprises a statistics module, said statistics module collecting data on expected response time and actual response time.

7. The email client as claimed in claim 6 including a statistics display module for displaying statistics on expected response time and actual response time.

8. The email client as claimed in claim 6 wherein said statistics module forwards said collected statistics to a server for further processing.

9. The email client as claimed in claim 1 wherein said client comprises an interface allowing a user to set parameters for adjusting the expected response time of incoming emails, said client processing each received email according to said rules.

10. The email client as claimed in claim 1 wherein said expected response time of outgoing emails are set according to a preference for the email address the email is sent to, said preference being stored in an address book, said email client having a default preference for cases when no specific preference is set.

11. An email message including an expected response time.

12. The email message including an expected response time field as claimed in claim 11 wherein said expected response time is stored in a field of said email.

13. The email message including an expected response time field as claimed in claim 12 wherein said expected response time field is included as an X-header field.

14. An email server adapted to process an email including an expected response time, said server responding to an email including an expected response time according to rules defined by a user and/or organisation.

15. The email server as claimed in claim 14 wherein said rules are set by a user using a user interface of an adapted email client.

16. The email server as claimed in claim 14 wherein said expected response time is stored in a field of said email.

17. The email server as claimed in claim 14 wherein said expected response time field is included as an X-header field.

18. The email system including the email client of claim 1.

19. A method of sending an email including the step of including an email expected response time field in said email.

20. A response time expectation system, including a processor;
digital storage media suitable for storing instructions and data;
a transceiver;
system instructions stored on the storage media configured for directing the processor to include expected response time information in a data transmission to a remote terminal, said expected response time information including data related to an expected response time for a response to the data transmission.

21. The response time expectation system as claimed in claim 20, wherein the system instructions are configured to send a data transmission to third party, which data transmission comprises
information relating to the expected response time for storage in database by the third party supplier, and an identifier code by which the third party database can be interrogated to return the expected response time.

22. The response time expectation system as claimed in claim 20, wherein the expected response time information including data related to an expected response time which is sent to the remote terminal comprises
a web link to the third party's site where the expected response time can be viewed, and
an identifier code by which the third party supplier database can be interrogated to return the expected response time.

23. The response time expectation system as claimed in claim 20, wherein the data transmission is an email message.

24. The response time expectation system as claimed in claim 20, wherein the expected response time information is stored in the body of the email message.

25. The response time expectation system as claimed in claim 20, wherein the expected response time information is stored in the X-header field of the email message.

26. The response time expectation system as claimed in claim 20, wherein the response time expectation system is an email client, a part thereof, or an addition thereto.

27. The response time expectation system as claimed in claim 20, wherein the system comprises
a screen display; and
the system instructions stored on the storage media are configured for
receiving a data transmission from a remote terminal including information relating to an updated expected response time for a particular data transmission; and
presenting an indication of the updated expected response time in association with the original data transmission on the screen display.

28. The response time expectation system as claimed in claim 20, wherein the information relating to an updated expected response time received from the remote terminal is received from the receiver of the original email.

29. The response time expectation system as claimed in claim 20, wherein the information received from the remote terminal is received from a third party.

30. The response time expectation system as claimed in claim 20, wherein the presentation of an indication of the updated expected response time is a web link to a web site, on which the updated expected response time is displayable.

31. The response time expectation system as claimed in claim 20, wherein the information relating to an updated expected response time comprises a web link to a third party website which will allow viewing of an updated expected response time.

32. The response time expectation system as claimed in claim 20, wherein the presentation of the updated expected response time is in response to an interrogation of the system by a user, and the system comprises instructions for carrying out said interrogation.

33. The response time expectation system as claimed in claim 20, wherein the updated expected response time is presented automatically on receipt of the updated information.

34. The response time expectation system as claimed in claim 20, wherein the system instructions are further configured for sorting email based on the expected response times, or updated expected response times.

35. The response time expectation system as claimed in claim 20, wherein the system instructions stored on the storage media are further configured for
receiving a data transmission from a remote terminal, said data transmission including expected response time information indicative of the time expected by the sender of the data transmission for an action to be performed by the receiver of the data transmission; and
updating the expected response time to reflect the update.

36. The response time expectation system as claimed in claim 20, wherein the system instructions are further configured for communicating the updated expected response time to the sender of the data transmission.

37. The response time expectation system as claimed in claim 20, wherein the system instructions are further configured for communicating the updated expected response time to a centralised database where the updated expected response time can be viewed.

38. The response time expectation system as claimed in claim 20, wherein the system instructions are further configured for presenting a user operable interface for general adjustment of expected response times of received emails.

39. The response time expectation system as claimed in claim 20, wherein the system instructions are further configured for presenting a user operable interface for adjustment of expected response times of received emails based on the characteristics of that email.

40. The response time expectation system as claimed in claim 20, wherein the adjustment of expected response times of received emails based on the characteristics of that email are based on characteristics such as
sender;
sender group;
user defined groups;
when the email is received;
location of sender; or
any other known characteristic.

41. The response time expectation system as claimed in claim 20, wherein the system instructions are further configured for presenting a user operable interface for adjustment of expected response times of received emails based on predetermined rules.

42. The response time expectation system as claimed in claim 20, wherein the predetermined rules relate to
work carried out,
whether a user is on leave or not,
the number of emails already having been received at that terminal that day, or over any other time period
the number of unread emails in the inbox at the terminal.
the amount if time spent responding to emails already over a preset time period;
the number of emails already responded to in a predetermined time period;
a preset default;
any other rule.

43. The response time expectation system as claimed in claim 20, wherein a preset default rule is settable by means of a graphical user interface shown as a slider bar, which slider bar is adjustable by a user according to their preference.

44. The response time expectation system as claimed in claim 20, wherein the system instructions stored on the storage media are further configured for recording details of when the data transmission is responded to or actioned.

45. The response time expectation system as claimed in claim 20, wherein the system instructions are further configured for communicating recorded details of when data transmissions are responded in relation to their expected response time, or in relation to their updated expected response times.

46. The response time expectation system as claimed in claim 20, wherein the system instructions are configured for raising an alert if a predetermined amount of emails are not responded to by the expected response time or updated expected response time, or if a particular predetermined rate of emails per hour or day are not being responded to by the expected response time or updated expected response time.

47. A data logging system comprising
digital storage media;
a transceiver; and
logging software configured for
receiving statistical data from a remote terminal, said data being indicative of indicative of when data transmissions are responded to in relation to their expected response time, or in relation to their updated expected response times;
storing the statistical data;
interrogating the stored statistical data to present information relating to data received from a remote terminal, or defined groups of remote terminals.

48. The data logging system as claimed in claim 47, wherein the logging software is configured to display the results the said interrogation on a display means.

49. A The data logging system as claimed in claim 47, wherein the logging software is configured to display the results of the said interrogation online over the Internet.

50. The data logging system as claimed in claim 47, wherein the response time expectation system comprises the data logging system.

51. The data logging system as claimed in claim 47, wherein the transceiver is a network card and/or network connection.

52. A method of communication an expected response time, said method comprising the steps of
directing a processor to include expected response time information in a data transmission to a remote terminal, said expected response time information including at least data indicative of the response time expected by the sender of the data transmission for a response to the data transmission; and
sending the data transmission to a remote terminal over a communications network.

53. The method of communication an expected response time as claimed in claim 52, wherein the method of communication an expected response time comprises the steps of
sending a data transmission to a third party over a communications network for storage on a database, which data transmission comprises
information relating to the expected response time for storage in database by the third party supplier, and
an identifier code by which the third party database can be interrogated to return the expected response time.

54. The method of communication an expected response time as claimed in claim 52, wherein the expected response time information including data related to an expected response time which is sent to the remote terminal comprises
a web link to the third party's site where the expected response time can be viewed, and
an identifier code by which the third party supplier database can be interrogated to return the expected response time.

55. The method of communication an expected response time as claimed in claim 52, wherein the data transmission is an email.

56. The method of communication an expected response time as claimed in claim 52, wherein the expected response time information which is included in the email is included in the body of the email.

57. The method of communication an expected response time as claimed in claim 52, wherein the expected response time information which is included in the email is included in the X-header field of the email.

58. A method of updating an expected response time for a data transmission, said method of updating comprising the steps of
receiving a data transmission from a remote terminal, said data transmission including response time information indicative of the time expected by the sender of the data transmission for an action to be performed by the receiver of the data transmission; and
updating the response time information to reflect a changed response time.

59. The method of updating an expected response time as claimed in claim 58, wherein the method of updating an expected response time comprises the step of sending information indicative of an updated expected response time to a remote terminal.

60. The method of updating an expected response time as claimed in claim 59, wherein the remote terminal is the remote terminal that sent the original data transmission.

61. The method of updating an expected response time as claimed in claim 58, wherein the method of updating an expected response time comprises the steps of
sending a data transmission to a third party over a communications network for storage on a database, which data transmission comprises
information relating to the updated expected response time for storage in database by the third party supplier, and
an identifier code by which the third party database can be interrogated to return the updated expected response time.

62. The method of updating an expected response time as claimed in claim 58, wherein the method of updating an expected response time comprises the steps of
accessing a third party's website
interrogating a database of stored expected response times associated with data transmission with a supplied identifier code; and
updating the expected response time associated with a particular data transmission.

63. The method of updating an expected response time as claimed in claim 58, wherein the updated expected response time information including data related to an updated expected response time which is sent to the remote terminal comprises
a web link to the third party's website where the updated expected response time can be viewed, and
an identifier code by which the third party supplier database can be interrogated to return the updated expected response time.

64. The method of updating an expected response time as claimed in claim 58, wherein the method of updating an expected response time comprises the step of presenting an indication of the updated response time in association with the original data transmission.

65. The method of updating an expected response time as claimed in claimed in claim 58, wherein the method of updating an expected response time comprises the step of recording details of when the data transmission is responded to.

66. The method of updating an expected response time as claimed in claimed in claim 58, wherein the method of updating an expected response time comprises the step of communicating recorded details of when data transmissions are responded in relation to their expected response time, or in relation to their updated expected response times to a remote terminal.

67. A method of receiving an updated expected response time comprising the steps of
receiving information related to an updated expected response time from a remote terminal; and
updating the expected response time associated with a data transmission.

68. A method of receiving an updated expected response time comprising the steps of
receiving a data transmission from a third party indicative of an updated expected response time associated with a previous data transmission,
accessing a third party's website to view the updated expected response time.

69. The method of receiving an updated expected response time as claimed in claim 68, wherein the method comprises the steps of
downloading the updated expected response time and
updating the expected response time associated with a data transmission.

70. The method of receiving an updated expected response time as claimed in claim 68, wherein the data transmission from a third party indicative of an updated expected response time comprises a web link, and an identifier code with which a database can be interrogated to return an updated expected response time.

71. The method of receiving an updated expected response time as claimed in claimed in claim 68, wherein the step of accessing the third party's website to view the updated expected response time comprises the step of sending the identifier code to the third party's website for interrogation of a database to return an updated expected response time.

72. The method of receiving an updated expected response time as claimed in claim 68, wherein on interrogation of the third party's data base, the updated expected response time associated with the sent data transmission is automatically updated.

73. A method of providing a response time expectation system time for a data transmission comprising the steps of receiving a data transmission associated with a spearte data transmission including:
(i) data indicative of an expected response time for the separate data transmission and
(ii) an associated identifier code storing the data indicative of an expected response time and associated identifier code for interrogation.

74. The method of providing a response time expectation system time as claimed in claim 73, wherein the method of providing a response time expectation system time for a data transmission comprises the steps of
receiving an identifier code from a receiver of the separate data transmission
interrogating the stored identifier codes for a similar identifier code to the one received; and
retrieving the associated data indicative of an expected response time.

75. The method of providing a response time expectation system time as claimed in claim 73, wherein the method of providing a response time expectation system time for a data transmission comprises the steps of
sending the associated data indicative of an expected response time to a remote terminal associated with the receiver of the separate data transmission.

76. The method of providing a response time expectation system time as claimed in claim 73, wherein the method of providing a response time expectation system time for a data transmission comprises the steps of
displaying the associated data indicative of an expected response time.

77. The method of providing a response time expectation system time as claimed in claim 73, wherein the method of providing a response time expectation system time for a data transmission comprises the steps of
receiving data indicative of an updated expected response time; and
storing the data indicative of an updated expected response time.

78. The method of providing a response time expectation system time as claimed in claim 73, wherein the method of providing a response time expectation system time for a data transmission comprises the steps of
sending a data transmission to the sender of the separate data transmission indicative of the updated expected response time.

79. The method of providing a response time expectation system time as claimed in claim 73, wherein the method of providing a response time expectation system time for a data transmission comprises the steps of
receiving an identifier code from a remote terminal associated with the updated expected response time;
interrogating the stored data indicative of the updated expected response times with the identifier code to retrieve data indicative of the updated expected response time.

80. The method of providing a response time expectation system time as claimed in claim 73, wherein the method of providing a response time expectation system time for a data transmission comprises the steps of
sending the associated data indicative of an updated expected response time to a remote terminal.

81. The method of providing a response time expectation system time as claimed in claim 73, wherein the remote terminal is associated with the sender of the separate data transmission.

82. The method of providing a response time expectation system time as claimed in claim 73, wherein the method of providing a response time expectation system time for a data transmission comprises the steps of
displaying the associated data indicative of an updated expected response time.

83. A method of logging and displaying response time data comprising the steps of
receiving statistical data from a remote terminal, said statistical data being indicative of when data transmissions are responded to by the remote terminal in relation to the expected response time of the data transmission, or in relation to the updated expected response times of the data transmission; and
storing the statistical data.

84. The method of logging and displaying response time data as claimed in claim 83, wherein the method of logging and displaying data comprises the step of
interrogating the stored statistical data to present statistical information relating to data received from a remote terminal, or defined groups of remote terminals.

85. An installation system for providing a system for modifying emails as described above, said system for providing a system comprising
digital storage media;
installation instructions stored on said digital storage media, said installation instructions being configured for directing a processor to install system instructions on a second digital storage media, said system instructions being configured for directing a processor to include response time information in a data transmission to a remote terminal, said response time information including at least data indicative of the time expected by the sender of the data transmission for an action to be preformed by the receiver of the data transmission.

86. The installation system as claimed in claim 85, wherein the data transmission is an email message.

87. The installation system as claimed in claimed in claim 85, wherein the response time information is stored in the body of the email message.

88. The installation system as claimed in claim 85, wherein the installation instructions are for further directing a processor to install system instructions on a second digital storage media configured for
receiving a data transmission from a remote terminal including updated information relating to the expected response time; and
presenting an indication of the updated response time in association with the original data transmission.

89. The installation system as claimed in claim 85, wherein the system for providing comprises download instructions for making said installation instructions available to a remote terminal.

90. The installation system as claimed in claim 85, wherein the processor is at a remote terminal.

91. An installation method of installing a system for modifying emails as described above, said installation method comprising the steps of
making computer readable installation instructions available to users, said installation instructions being configured for directing a processor to install system instructions on a second digital storage media, said system instructions being configured for directing a processor to include response time information in a data transmission to a remote terminal, said response time information including at least data indicative of the time expected by the sender of the data transmission for an action to be preformed by the receiver of the data transmission.

92. The installation method as claimed in claim 91, wherein the installation instructions are made available online over the Internet.

93. The installation method as claimed in claim 91, wherein the installation instructions are made available on a digital storage media.

94. The installation method as claimed in claim 91, wherein the digital storage media is a CD, DVD, flash memory, hard disc, or the like.

95. The installation method as claimed in claim 91, wherein the data transmission is an email message.

96. The installation method as claimed in claim 91, wherein the response time information is stored in the body of the email message.

97. The installation method as claimed in claim 91, wherein the installation instructions are for further directing a processor to install system instructions on a second digital storage media configured for
receiving a data transmission from a remote terminal including updated information relating to the expected response time; and
presenting an indication of the updated response time in association with the original data transmission.

98. The installation method as claimed in claim 91, wherein the system for providing comprises download instructions for making said installation instructions available to a remote terminal.

99. The installation method as claimed in claim 91, wherein the processor is at a remote terminal.
